(19) United States
(12) Patent Application Publication
(10) Pub. No.: US 2006/0052236 A1
(43) Pub. Date: Mar. 9, 2006

(54) Hydroprocessing catalyst with zeolite and high mesoporosity

(76) Inventors: Philip J. Angevine, Woodbury, NJ (US); Xingtao Gao, Edison, NJ (US); Zhiping Shan, Austin, TX (US)

Correspondence Address: DILWORTH & BARRESE, LLP, 333 EARLE OVINGTON BLVD., UNIONDALE, NY, 11553, US

(21) Appl. No.: 11/221,222

(22) Filed: Sep. 7, 2005

Related U.S. Application Data
(63) Continuation-in-part of application No. 11/101,858, filed on Apr. 8, 2005.
Application No. 11/101,858 is a division of application No. 10/313,720, filed on Dec. 6, 2002, now Pat. No. 6,930,219.
Application No. 10/313,720 is a continuation-in-part of application No. 09/995,227, filed on Nov. 27, 2001, now Pat. No. 6,762,143.
Application No. 09/995,227 is a continuation-in-part of application No. 09/390,276, filed on Sep. 7, 1999, now Pat. No. 6,358,486.
(60) Provisional application No. 60/607,607, filed on Sep. 7, 2004.

(51) Int. Cl. B01J 29/06

(52) U.S. Cl. 502/66; 502/64

(57) ABSTRACT

A catalyst for hydrocarbon conversion includes at least the following three components (1) at least one element with a hydrogenation function, (2) at least one type of microporous zeolite, and (3) a porous, noncrystalline inorganic oxide having randomly interconnected mesopores and having an X-ray reflection in 2θ between 0.5 degrees to 2.5 degrees.

### CROSS REFERENCE TO RELATED APPLICATIONS

The present application claims priority to U.S. Provisional application Ser. No. 60/607,607 filed Sep. 7, 2004. The present application is a continuation-in-part of copending U.S. application Ser. No. 11/101,858 filed Apr. 8, 2005, which is a divisional of U.S. application Ser. No. 10/313,720 filed Dec. 6, 2002, which is a continuation-in-part of U.S. application Ser. No. 09/995,227 filed Nov. 27, 2001 and now issued as U.S. Pat. No. 6,762,143, which is a continuation-in-part of U.S. application Ser. No. 09/390,276 filed Sep. 7, 1999, and now issued as U.S. Pat. No. 6,358,486, to which priority is claimed, all of the aforementioned applications and/or patents being incorporated by reference herein.

### BACKGROUND OF THE INVENTION

1. Field of the Invention

The present invention relates to a bifunctional catalyst having both hydrogenation and acidic functions.

2. Background of the Related Art

Most of today's hydrocarbon processing technologies are based on zeolite catalysts. Zeolite catalysts are well known in the art and possess well-arranged pore systems with uniform pore sizes. However, these materials tend to possess either only micropores or only mesopores. Micropores are defined as pores having a diameter less than about 2 nm. Mesopores are defined as pores having a diameter ranging from about 2 nm to about 50 nm.

Because such hydrocarbon processing reactions are mass-transfer limited, a catalyst with an ideal pore size will facilitate transport of the reactants to active catalyst sites and transport the products out of the catalyst.

There is yet need for an improved material having functionalized sites within a porous framework for processes directed to the catalytic conversion and/or adsorption of hydrocarbons and other organic compounds.

### SUMMARY OF THE INVENTION

A catalyst for hydrocarbon conversion is provided herein, the catalyst comprising at least three components (1) at least one element with a hydrogenation function, (2) at least one type of microporous zeolite, and (3) a porous, noncrystalline inorganic oxide having randomly interconnected mesopores and having an X-ray reflection in 2θ between 0.5 degrees to 2.5 degrees.

### BRIEF DESCRIPTION OF THE DRAWINGS

The invention is described hereinbelow with reference to the drawings wherein:

FIG. 1 depicts X-ray diffraction (XRD) patterns of pure zeolite beta and zeolite beta/TUD-1 as prepared in Examples 1, 2 and 3;

FIG. 2 depicts the mesoporosity of pure zeolite beta and zeolite beta/TUD-1 as prepared in Examples 1, 2 and 3;

FIG. 3 depicts XRD patterns for mesoporous material, MCM-22 zeolite, and the composite prepared in Example 4;

FIG. 4 illustrates the mesopore size distribution of the composite zeolite/TUD-1 prepared in Example 4; and,

FIG. 5 depicts XRD patterns of pure zeolite Y and of Sample 5 prepared in Example 5.

### DETAILED DESCRIPTION OF THE PREFERRED EMBODIMENT(S)

The inventive catalyst has a novel composition essentially comprising three active components: (1) at least one metal selected from group VIII, IB, IIB, VIIB and VIB in the periodic table of the elements; (2) at least one type of microporous zeolite providing some acidic function; and (3) a noncrystalline inorganic oxide having randomly interconnected mesopores ranging from 1.5 to 25 nm in diameter. The catalyst can also optionally include boron and/or phosphorus as another component. For physical integrity, the catalyst may further comprise a binder.

The metal is mainly selected from transition metals, noble metals and their combinations. These metals include titanium, vanadium, zirconium, manganese, zinc, copper, gold, lanthanum, chromium, molybdenum, nickel, cobalt, iron, tungsten, palladium, rhodium, ruthenium and platinum. Some of the metals can be located on the pore surface of the mesoporous, inorganic oxide; some of them can be incorporated within the zeolite framework as substitutions of lattice atoms and/or located inside the zeolite micropores. Also, some of the metal can be located on the catalyst binder.

The metal content in the catalyst, depending on the specific applications, ranges from 0.3 wt. % to 30 wt. % based on the weight of the catalyst. For noble metals its contents preferably ranges from 0.2 to 5 wt %, and for transition metals its contents preferably ranges from 3 to 30 wt. %.

The zeolite described herein includes a microporous zeolite embedded in a non-crystalline, porous inorganic oxide. The microporous zeolite can be any type of microporous zeolite. Some examples are zeolite Beta, zeolite Y (including “ultra stable Y”—USY), mordenite, Zeolite L, ZSM-5, ZSM-11, ZSM-12, ZSM-20, Theta-1, ZSM-23, ZSM-34, ZSM-35, ZSM-48, SSZ-32, PSH-3, MCM-22, MCM-49, MCM-56, ITQ-1, ITQ-2, ITQ-4, ITQ-21, SAPO-5, SAPO-11, SAPO-37, Breck-6 (also known as EMT), ALPO₄-5, etc. Such zeolites are known in the art, and many are commercially available. In this invention, the zeolite can be incorporated into the inorganic oxide or can be in-situ synthesized in the noncrystalline porous oxide.

The catalyst's zeolite content can range from less than about 1% by weight to more than about 99% by weight or any range therebetween. However, it is preferably from about 3% by weight to 90% by weight, and more preferably from about 4% by weight to about 80% by weight. The catalyst with zeolite included preferably contains no more than about 10 volume percent of micropores.

The noncrystalline, porous inorganic oxide is preferably a three-dimensional, mesoporous inorganic oxide material containing at least 97 volume percent mesopores (i.e., no more than 3 volume percent micropores) based on micropores and mesopores of the inorganic oxide material (i.e., without any zeolite incorporated therein), and generally at least 98 volume percent mesopores. This material is described in U.S. Pat. No. 6,358,486, and it is denoted as TUD-1. A method for making a preferred porous inorganic oxide is disclosed in U.S. Pat. No. 6,358,486 and U.S. patent application Ser. No. 10/764,797.

The main chemical composition of the preferred porous inorganic oxide (TUD-1) includes, but is not limited to, silica, alumina, silica-alumina, titanium oxide, zirconium oxide, magnesium oxide and their combination. The porous inorganic oxide TUD-1 can further comprise vanadium, zinc, copper, gold, gallium, lanthanum, chromium, molybdenum, nickel, cobalt, iron and tungsten.

TUD-1 is a noncrystalline material (i.e., no crystallinity is observed by presently available x-ray diffraction techniques). Its average mesopore size, as determined from N₂-porosimetry, ranges from about 2 nm to about 25 nm. The surface area of the inorganic oxide, as determined by BET (N₂), preferably ranges from about 200 m²/g to about 1200 m²/g. Its pore volume preferably ranges from about 0.3 cm³/g to about 2.2 cm³/g.

According to U.S. Pat. No. 6,358,486 and U.S. patent application Ser. No. 10/764,797, the mesoporous inorganic oxide is generally prepared by heating a mixture of (1) a precursor of the inorganic oxide, and (2) an organic templating agent that mixes well with the oxide precursor or the oxide species generated from the precursor. The starting material is generally an amorphous material and may be comprised of one or more inorganic oxides such as silicon oxide or aluminum oxide, with or without additional metal oxides. The silicon atoms may be replaced in part by other metal atoms. These metals include, but are not limited to, aluminum, titanium, vanadium, zirconium, gallium, boron, manganese, zinc, copper, gold, lanthanum, chromium, molybdenum, nickel, cobalt, iron, tungsten, palladium and platinum. These metals can be incorporated into the inorganic oxide inside mesopore wall and/or on the mesopore surface. The additional metals may optionally be incorporated into the material prior to initiating the process for producing a structure that contains mesopores. Also after preparation of the material, cations in the system may optionally be replaced with other ions such as those of an alkali metal (e.g., sodium, potassium, lithium, etc.)

The organic templating agent, a mesopore-forming organic compound, is preferably a glycol (a compound that includes two or more hydroxyl groups), such as glycerol, diethylene glycol, triethylene glycol, tetraethylene glycol, propylene glycol, and the like, or member(s) of the group consisting of triethanolamine, triisopropanolamine, sulfolane, tetraethylene pentamine and diethylglycol dibenzoate. Preferably, the organic templating agent has a boiling point of at least about 150° C.

In order to incorporate zeolite into the porous inorganic oxide, the preferred process is described in U.S. Pat. No. 6,762,143 and US patent publication 2004/0138051. The preformed zeolite and/or pretreated zeolite are suspended in a mixture with water. Then the suspension is mixed with an inorganic oxide or a precursor of an inorganic oxide, and at least one mesopore-forming organic compound to form a mixture. The mixture preferably forms gel by ageing and/or stirring at certain temperature from room temperature to 100° C. and/or by drying at a temperature from 60-120° C. Then the gel is heated up to a temperature from 140 to 200° C. and for a period of time sufficient to form a mesoporous inorganic oxide structure. Finally the organic pore-forming agent is removed by extraction or extraction together with calcination to obtain a composition having zeolite incorporated into a noncrystalline, porous inorganic oxide.

In addition, U.S. patent application Ser. No. 10/764,797 discloses a method to prepare the noncrystalline, porous inorganic oxide by using complexes. Complexes such as, e.g., silitrane, alumatrane, titanatrane, and particularly, silicon-triethanolamine, aluminum-triethanolamine and their mixture can be used as the precursor of the noncrystalline, porous inorganic oxide. Following the process described in U.S. Pat. No. 6,762,143 and US patent application 2004/0138051, a composition having zeolite incorporated into a noncrystalline, porous inorganic oxide (TUD-1) can be obtained.

The said metal having a hydrogenation function can be introduced into the catalyst in different stages of catalyst preparation. After the preparation of the composite having zeolite in the noncrystalline porous inorganic oxide (denoted as zeolite/TUD-1), the metal can be loaded by conventional impregnation and ion exchange. It is also possible that the metal is introduced into zeolite before zeolite incorporated into the porous inorganic oxide (TUD-1) by impregnation or ion exchange. In practice, the zeolite/TUD-1 is preferable to be shaped using certain binders, such as alumina. After catalyst shaping, the metal can be introduced to the catalyst.

The composite zeolite/TUD-1 impregnates with at least one solution containing at least one element from group VIB, VIIB, IB, IIB and VIII. Sources of group VIB elements that can be used are well known to the skilled person. Examples of molybdenum and tungsten sources are oxides and hydroxides, molybdic acids and tungstic acids and their salts, in particular ammonium salts such as ammonium molybdate, ammonium heptamolybdate, ammonium tungstate, phosphomolybdic acid, phosphotungstic acid and their salts, silicomolybdic acid, silicotungstic acid and their salts. Preferably, oxides and ammonium salts are used, such as ammonium molybdate, ammonium heptamolybdate and ammonium metatungstate.

The sources of the group VIII, VIIB, IB and IIB elements that can be used are well known to the skilled person. Examples of sources of nonnoble metals are nitrates, sulfates, phosphates, halides, for example chlorides, bromides and fluorides, and carboxylates, for example acetates and carbonates. Examples of sources of noble metals are halides, for example chlorides, nitrates, acids such as chloroplatinic acid, and oxychlorides such as ammoniacal ruthenium oxychloride.

The catalysts obtained in the present invention are formed into grains of different shapes and dimensions. They are generally used in the form of cylindrical or polylobed extrudates (e.g. bilobes, trilobes, or quadrulobes) with a straight or twisted shape, but they can also be produced and used in the form of compressed powder, tablets, rings, beads or wheels.

The catalyst can be used in hydrocracking, hydrotreating, and hydroisomerization, in which all catalysts are bifunctional, combining an acid function and a hydrogenating function. It is important to balance these two functions in a certain process. The metal selected from transition metal and noble metal offers hydrogenation function. The incorporated zeolite offers acid function. The noncrystalline porous oxide, TUD-1, can offer acid function and/or hydrogenation function, depending the chemical composition of the oxide. For example, the porous oxide is a mixed oxide, silica-alumina, and then it supplies acid function. The porous oxide is silica containing nickel and molybdenum; it offers hydrogenation function. In addition, the porous oxide may not offer any acid and hydrogenation function, for example, if the porous oxide is pure silica. So this novel catalyst has a great deal of flexibility to adjust acid function and hydrogenation function.

Another important feature of this catalyst offers high mesoporosity by using the noncrystalline porous oxide, significantly enhancing mass-transfer and consequently improves the catalytic performance. For most liquid-phase processes, intraparticle mass-transfer limitations reduce catalyst utilization and lower overall catalytic performance. Introduction of mesoporosity will boost the overall catalytic performance. Moreover, many refining processes are using heavy petroleum feeds, which need large pores to facilitate the big molecules into and out the catalytic particles. Petroleum feeds can include, for example, undeasphalted petroleum residua, deasphalted petroleum residua, tar sands bitumen, shale oil and coal liquid. As such, the noncrystalline, porous oxide TUD-1 having mesopores size from 1.5 to 30 nm can fulfill the need to enhance the mass-transfer.

In addition, the noncrystalline, porous oxide has not only tunable mesopores, but also has randomly interconnected mesopores. As described in U.S. Pat. No. 6,358,486, its randomly interconnected mesopores structure distinguishes from other mesoporous materials, such as MCM-41. The randomly interconnected mesopores reduce the chance of pore blockage compared to the materials with one- or two-dimensional pore system. Thus the novel catalyst will have a longevity advantage regarding pore blockage deactivation.

In the process of hydrocracking, the balance between acid and hydrogenation functions is a fundamental parameter which influences both activity and selectivity of the catalyst. A weak acid function and a strong hydrogenation function produce low activity catalysts, which generally require a high reaction temperature (390° C. or above) and a low space velocity (LHSV generally 2 h⁻¹ or less), but generally have very good selectivity for middle distillates. In contrast, a strong acid function and a weak hydrogenation function produce very active catalysts, but selectivity for middle distillates are poorer; this catalyst combination may also adversely impact aging stability. The search for suitable catalysts thus revolves around the proper selection of each of the functions to adjust the activity/selectivity/stability balance of the catalyst.

In order to get good selectivity for middle distillates in hydrocracking process, the catalyst preferably have noncrystalline silica-aluminas as porous material, have zeolites selected from zeoliteY, ZSM-5, zeolite Beta, MCM-56 and/or MCM-22, and have metals selected from group VIII and/or VIB in the periodic table. It is even preferable that, given a significant, heteroatomic poison content in the feed, some metals of group VIB and VIII are in the sulfided or oxysulfided form.

One conventional sulfiding method which is well known to the skilled person consists of heating in the presence of hydrogen sulfide (pure or, for example, in a stream of a hydrogen/hydrogen sulfide mixture or a nitrogen/hydrogen sulfide mixture) to a temperature in the range 150° C. to 800° C., preferably in the range 250° C. to 600° C., generally in a traversed bed reaction zone.

The hydrocracking process conditions (e.g. temperature, pressure, hydrogen circulation rate, and space velocity) can vary widely depending on the nature of the feed, the quality of the desired products and the facilities available to the refiner. The temperature is generally over 200° C., and usually in the range 250° C. to 480° C. The pressure is over 0.1 MPa and usually over 1 MPa. The quantity of hydrogen is a minimum of 50 liters of hydrogen per liter of feed and usually in the range 80 to 5000 liters of hydrogen per liter of feed. The hourly space velocity is generally in the range 0.1 to 20 volumes of feed per volume of catalyst per hour. Hydrocracking products can include, for example, middle distillates with a boiling range of from about 150° C. to about 400° C., diesel fuel and lube base oil.

Generally the hydroisomerization catalyst, e.g. for upgrading a Fischer-Tropsch product (disclosed in U.S. Pat. No. 6,570,047), comprises one or more Group VIII catalytic metal components supported on an acidic metal oxide support to give the catalyst both a hydrogenation function and an acid function for hydroisomerizing the hydrocarbons. Hydroisomerization conditions typically include a temperature of from about 150° C. to about 500° C., a pressure from about 1 bar to about 240 bars, and a LHSV from about 0.1 to about 20. At relatively low hydroisomerizing temperatures, such as those in a hydrocarbon synthesis reactor, the catalytic metal component may comprise a Group VIII noble metal, such as Pt or Pd, and preferably Pt. However, at the higher temperatures which can be employed with the process of the invention, it is preferred that the catalytic metal component comprise one or more less expensive, non-noble Group VIII metals, such as Co, Ni and Fe, which will typically also include a Group VIB metal (e.g., Mo or W) oxide promoter. The catalyst may also have a Group IB metal, such as copper, as a hydrogenolysis suppressant. Phosphorus may also be included to enhance the solubility of the metals and to aid in overall stability.

The cracking and hydrogenating activity of the catalyst is determined by its specific composition, as is known. The present invention provides a preferred catalyst composition having catalytically active metal, e.g. cobalt and molybdenum, the oxide support or carrier including silica, alumina, silica-alumina, silica-alumina-phosphates, titania, zirconia, vanadia, and other Group II, IV, V or VI oxides, as well as acidic zeolite, such as zeolite Y (including USY), zeolite Beta and ZSM-5.

The following examples illustrate the present invention without in any way limiting its scope.

### EXAMPLE 1

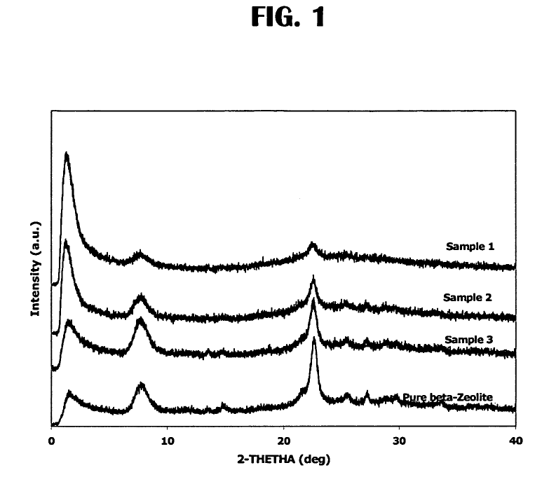

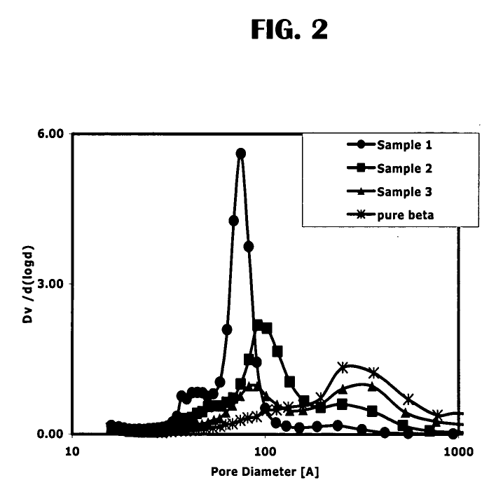

This example demonstrates the incorporation of zeolite Beta into silica TUD-1. First, 4.6 parts calcined zeolite Beta with a SiO₂/Al₂O₃ molar ratio of 75 and an average particle size of 0.2 μm were suspended in 51 parts water and stirred for 30 minutes. Then 23 parts triethanolamine were added to the suspension while stirring. After continuous stirring for another 30 minutes, 63.5 parts tetraethyl orthosilicate (“TEOS”) were added. After stirring again for another 30 minutes, 12.6 parts tetraethylammonium hydroxide aqueous solution (35%) were added drop-wise to the mixture. After stirring for about 2 hours, the mixture formed a thick, nonflowing gel. This gel was aged at room temperature under static conditions for 24 hours. Next, the gel was dried in air at 100° C. for 24 hours. The dried gel was transferred into autoclaves and hydrothermally treated at 180° C. for 4 hours. Finally, it was calcined at 600° C. for 10 hours in air with a heating rate of 1° C./min. The XRD pattern of the resultant product, designated as Sample 1, is shown in FIG. 1, which clearly shows two characteristic peaks of zeolite beta. There is about 20 wt % zeolite beta in the final composite. Nitrogen adsorption revealed its surface area of about 730 m²/g, pore volume of about 1.08 cm³/g. The mesopore size distribution of Sample 1 is shown in FIG. 2.

### EXAMPLE 2

The zeolite Beta used here is the same as that in Example 1. First, 12.2 parts zeolite Beta were suspended in 51 parts water and stirred for 30 minutes. Then 23 parts triethanolamine were added to the suspension with stirring. After continuous stirring for another 30 minutes, 63.5 parts TEOS were added. After stirring again for another 30 minutes, 12.7 parts tetraethylammonium hydroxide aqueous solution (35%) were added drop-wise to the mixture. The same procedure was followed as described in Example 1. After calcination, its XRD pattern (corresponding to Sample 2) is shown in FIG. 1, which clearly shows two characteristic peaks of zeolite Beta. There is about 40 wt % zeolite Beta in the final composite zeolite/TUD-1. Nitrogen adsorption revealed its surface area of about 637 m²/g, pore volume of about 1.07 cm³/g. Its mesopore size distribution is shown in FIG. 2.

### EXAMPLE 3

The same zeolite Beta and procedure were used as described in Example 1, except for the chemical amounts. They were 9.2 parts zeolite Beta, 17 parts water, 7.6 parts triethanolamine 21.2 parts TEOS, and 4.2 parts of tetraethylammonium hydroxide aqueous solution (35%). The final product, designated as Sample 3, was characterized by XRD and gas adsorption. Its XRD pattern in FIG. 1 clearly shows two characteristic peaks of zeolite Beta. There was about 60 wt % zeolite Beta in the final composite. Nitrogen adsorption revealed its surface area of about 639 m2/g, pore volume of about 0.97 cm3/g. Its mesopore size distribution is shown in FIG. 2.

### EXAMPLE 4

This example illustrates incorporation of MCM-22. First, 2.4 parts as-synthesized zeolite MCM-22 with a SiO₂/Al₂O₃ molar ratio of 6.4 and an average particle size of 2.5 μm were suspended in 10.5 parts water and stirred for 30 minutes. Then 9.2 parts triethanolamine were added to the above suspension under stirring. After continuous stirring for another 30 minutes, 12.7 parts TEOS were added. After stirring again for another 30 minutes, 2.52 parts tetraethylammonium hydroxide aqueous solution (35%) were added drop-wise to the mixture. After stirring for about 2 hours, the mixture formed a thick, nonflowing gel. This gel was aged at room temperature under static conditions for 24 hours. Next, the gel was dried in air at 98° C. for 24 hr. The dried gel was transferred into autoclaves and hydrothermally treated at 180° C. for 4 hours. Finally, it was calcined at 600° C. for 10 hours in air with a heating rate of 1° C./min.

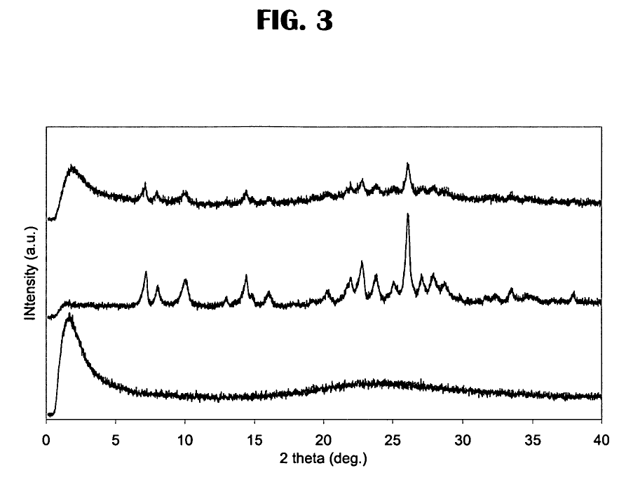

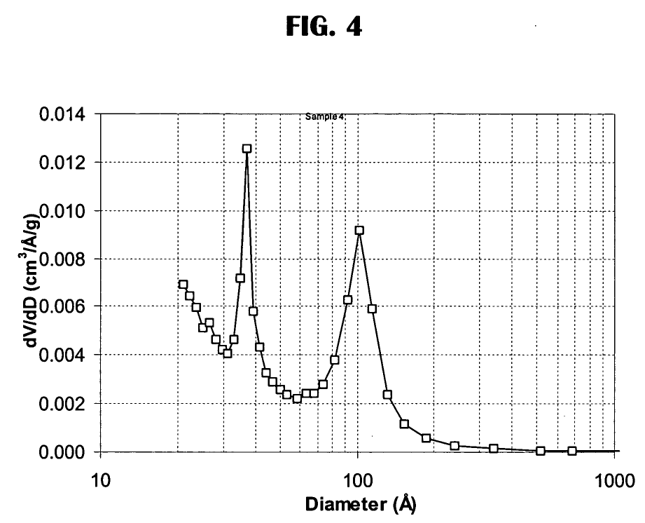

The XRD pattern of the resultant product, designated as Sample 4 and shown as the uppermost plot in FIG. 3, clearly shows characteristic peaks of zeolite MCM-22 (middle plot) and mesoporous material (lowest plot). There is about 40 wt % zeolite MCM-22 in Sample 4, and elemental analysis confirmed this number based on aluminum content, assuming no aluminum from siliceous mesoporous material. Nitrogen adsorption revealed its surface area of about 686 m^{2/}g, pore volume of about 0.82 cm³/g. Its mesopore size distribution centered around 10 nm in FIG. 4. Argon adsorption showed micropores centered at 0.5 nm.

### EXAMPLE 5

An ultrastable Y (USY) having a SiO₂/Al₂O₃ molar ratio of 14.8 and a surface area of 606 m²/g was incorporated into an aluminum-containing mesoporous matrix. First, 2.9 parts ultrastable zeolite Y were suspended in 17.0 parts water and stirred for 30 minutes. Then 124 parts triethanolamine were added to the above suspension under stirring. After continuous stirring for another 30 minutes, another mixture containing 171.4 parts of TEOS and 28 parts of aluminum isopropoxide were added under stirring. After stirring again for another 30 minutes, 34 parts tetraethylammonium hydroxide aqueous solution (35%) were added drop-wise to the mixture. After stirring for about 2 hours, the mixture formed a thick nonflowing gel. This gel was aged at room temperature under static conditions for 24 hours. Next, the gel was dried in air at 100° C. for 24 hours. The dried gel was transferred into an autoclave and hydrothermally treated at 180° C. for 2 hours. Finally, it was calcined at 600° C. for 10 hours in air with a heating rate of 1° C./min. The final material was designated as Sample 5.

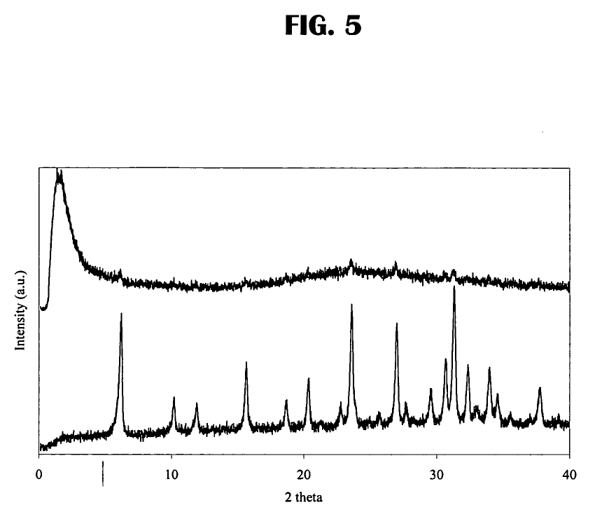

The XRD pattern of Sample 5 is shown as the upper plot in FIG. 5, which clearly shows two characteristic peaks of zeolite Y and mesostructure material. The lower plot depicts an XRD pattern of zeolite Y. There is about 5 wt % zeolite Y in the final composite. Nitrogen adsorption revealed its surface area of about 694 m²/g, pore volume of about 1.1 cm³/g.

### EXAMPLE 6

This example demonstrates catalyst extrusion using alumina as binder. The proton form (i.e. H⁺) of the Sample 5 was obtained by ion exchange, mixing one part of Composite 5 with ten parts of 1 N ammonium nitrate solution at 60° C. for 6 hours while stirring. The solid material was filtered, washed and dried at 110° C. to get a white powder. After a second ion exchange, the solid material was calcined at 550° C. for 6 hours in air.

Eight parts of H⁺-Sample 5 were mixed with two parts of alumina in the form of Nyacol to provide a catalyst. The mixture was extruded into cylindrical shape with 1.6 mm diameter. The extrudate was dried and calcined at 550° C. for 4 hours. Finally the extrudate contained about 4% USY, 76 wt % of Al-containing noncrystalline, porous oxide and 20 wt % alumina.

### EXAMPLE 7

This example demonstrates the preparation of silica precursor, silica-triethanolamine complexes. First, 250 parts of silica gel, 697 parts of triethanolamine (TEA) and 286 parts of ethylene glycol (EG) were loaded into a flask equipped with a condenser. After the contents of the flask were mixed well with a mechanical stirrer, the mixture was heated up to 200-210° C. while stirring. This setup removed most of water generated during reaction together with a small portion of EG from the top of the condenser. Meanwhile, most of the EG and TEA remained in the reaction mixture. After about six hours, heating was stopped; and the reaction mixture was collected after cooling down to 55° C. This reaction mixture was slightly brown, denoted as silica-triethanolamine complexes.

### EXAMPLE 8

This example demonstrates the zeolite/TUD-1 preparation using silica-triethanolamine complexes as a silica source. A suspension of 99 parts of zeolite Y (CBV-500) and 300 parts of water was loaded into grinding device for wet-milling. After 30 minutes of grinding at 3000 rpm, the suspension was collected for zeolite incorporation into silica TUD-1. Two hundred six (206) parts of this suspension (measured to be 20 wt % zeolite Y) was mixed with 217 parts of the complexes obtained in Example 7 under stirring. After 30 minutes, the mixture formed a thick gel followed drying at 90° C. for 24 hours. The dried gel was transferred into an autoclave and heated up to 180° C. and held there for 6 hours. Finally the gel was calcined at 600° C. for 10 hours in air and ultimately became a white powder.

The final zeolite/TUD-1 composite contains 45 wt % of zeolite. Nitrogen gas adsorption showed that it has a BET surface area of about 560 m ^{2/}g, total pore volume of 1.2 cm³/g and average mesopore size of about 5.7 nm.

### EXAMPLE 9

This is an example showing metals incorporation into the catalyst. The extrudate obtained in Example 6 is further functionalized by impregnation with Ni and W. Five (5) parts of nickel nitrate aqueous solution (14 wt % Ni) is mixed with 8.4 parts of ammonium metatungstate solution (39.8 wt % W) under stirring. The mixture is then diluted with 9 parts of water under stirring. 12.5 Parts of extrudate obtained in Example 6 are impregnated with the above Ni/W solution, dried at 118° C. for 2 hours and calcined at 500° C. for 2 hours. The resulting modified extrudates contains 4.0 wt % of Ni and 18.7 wt % W.

### EXAMPLE 10

This example demonstrates the preparation of 0.9 wt % palladium and 0.3 wt % platinum/zeolite-TUD-1 by incipient wetness. The zeolite/TUD-1 obtained in Example 2 is impregnated with an aqueous solution comprising 0.42 parts of tetraammine platinum nitrate, 12.5 parts of aqueous solution of tetraammine palladium nitrate (5% Pd) and 43 parts of water. Impregnated zeolite/TUD-1 is aged at room temperature for 5 hours before dried at 90° C. for 2 hours. The dried material is finally calcined in air at 350° C. for 4 hours with a heating rate of 1° C./min. Noble metal dispersion is measured using CO chemisorption; the powder is then reduced in a hydrogen stream at 100° C. for 1 hr followed by heating to 350° C. at 5° C./min and is maintained at this temperature for 2 hr. A dispersion of 51% is measured for the metal assuming a Pt:CO stoichiometry of 1.

### EXAMPLE 11

This example demonstrates catalyst preparation of 0.90 wt % iridium/zeolite/TUD-1 by incipient wetness. 0.134 Parts of iridium (III) chloride are dissolved in 5.3 parts of deionized water. This solution is added to 8 parts of zeolite/TUD-1 obtained in Example 4 with mixing. The powder was dried at 25° C.

For dispersion measurement using CO chemisorption, the powder is then reduced in a hydrogen stream at 100° C. for 1 hr followed by heating to 350° C. at 5° C./min and is maintained at this temperature for 2 hr. CO chemisorption showed a 78% dispersion for the metal assuming an Ir:CO stoichiometry of 1.

### EXAMPLE 12

This example illustrates the use of the catalyst obtained in Example 9 as a hydrocracking catalyst, which is evaluated for middle distillates selectivity in hydrocracking. The evaluation is carried out in a flow reactor with presulfided form (in a conventional way) using a hydrotreated heavy vacuum gas oil as a feedstock. It is operated at LHSV of 1.5 kg/liter hour, total pressure of 140 bar (partial pressure of H₂S of 5.5 bar, and a partial pressure of ammonia of 0.075 bar) and a gas/feed ratio of 1500 NL/kg. The properties of feedstock are shown in Table 1.

TABLE 1
Hydrotreated Heavy Vacuum Gas Oil Properties

| Distillation (D1160): | |
|---|---|
| IBP, ° C. (vol %) | 345 |
| 10% | 402 |
| 30% | 441 |
| 50% | 472 |
| 70% | 508 |
| 90% | 564 |
| EP | 741 |
| KV @ 100° C., cst | 8.81 |
| Carbon, wt % | 86.6 |
| Hydrogen, wt % | 13.4 |
| Total sulfur, wt % | 0.008 |
| Total Nitrogen, ppm | 16.1 |

The selectivity for middle distillates (e.g. boiling point range from 175° C. to 345° C.) is assessed at a net conversion of components of 65 wt %. Surprisingly, the selectivity reaches 72.6 wt %.

### EXAMPLE 13

This example demonstrates lube yield and viscosity index improvement. The composite zeolite/TUD-1 obtained in Example 6 is impregnated with tetraammine platinum nitrate as described in Example 9, and the final catalyst has about 0.6 wt % Pt. A typical, deoiled wax feed has the composition shown in Table 2 below. This deoiled wax is obtained from the solvent (MEK) dewaxing of a 300 SUS (65 cst) neutral oil obtained from an Arab Light crude. The total liquid product from the hydrocracking step is further upgraded and hydroisomerized by processing over a low acidity Pt/zeolite Beta/TUD-1 catalyst obtained to effectively hydroisomerize and convert most of the unconverted wax to very high quality, very high VI lube oil containing essentially all isoparaffins, primarily singly branched. The waxy total liquid product is processed over the catalyst at 400 psia H₂ partial pressure, 2500 SCF/B hydrogen, and 0.5 LHSV over a range of conversion levels. The total liquid product is then distilled to a nominal 700° F.+cut-point. The waxy bottoms are then solvent dewaxed to produce lube oils having improved lube yield. Table 3 contains results of these experiments using zeolite containing hydrocracking catalyst.

TABLE 2
Properties of Deoiled Wax

| | |
|---|---|
| Gravity, ° API | 39.2 |
| Hydrogen, wt % | 14.04 |
| Nitrogen, ppm | 9 |
| Sulfur, wt % | 0.01 |
| KV @ 100° F., cst | 6.294 |
| KV @ 300° F., cst | 3.15 |
| Pour Point, ° F. | 120 |
| Oil in Wax, D3235 | 3.1 |

Simulated Distribution D2887

| Wt % | ° F. |
|---|---|
| 0.5 | 759 |
| 5 | 811 |
| 10 | 830 |
| 20 | 860 |
| 30 | 878 |
| 40 | 899 |
| 50 | 917 |
| 60 | 938 |
| 70 | 959 |
| 80 | 983 |
| 90 | 1014 |
| 95 | 1038 |

TABLE 3
Pt/Zeolite Beta/TUD-1 Isomerization of
Low Conversion Hydrocracked Deoiled Wax

| | 1 | 2 | 3 | 4 | 5 |
|---|---|---|---|---|---|
| Reactor T, ° F. | — | 691 | 632 | 638 | 678 |
| 700° F.- Conv., wt % | 18 | 23.3 | 22.5 | 21.5 | 8.9 |
| (Overall) | | | | | |
| Solvent Dewaxed | | | | | |
| Oil Properties | | | | | |
| KV @ 40° C., cst | 19.04 | 18.05 | 23.2 | 22.33 | 23.07 |
| KV @ 100° C., cst | 4.457 | 4.299 | 5.195 | 5.04 | 5.089 |
| VI | 153 | 152 | 164 | 162 | 157 |
| Pour Point, ° F. | 0 | 5 | 15 | 10 | 5 |
| VI @ 0° F. Pour | 151 | 149 | 158 | 159 | 153 |
| Sim Dist (5% pt) | 674 | 557 | 732 | 705 | 623 |
| Composition, wt % | | | | | |
| Paraffins | 92 | 97 | 93 | 89 | 91 |
| Mononaphthenes | 5 | 0 | 3 | 2 | 2 |
| Polynaphthenes | 2 | 1 | 4 | 6 | 4 |
| Aromatics | 1 | 2 | 0 | 3 | 3 |
| Lube Yield, wt % | 31.7 | 49.4 | 42.3 | 50.1 | 53.8 |
| (Deoiled Wax Feed) | | | | | |
| Wax conversion, % | 47.1 | 68.9 | 61.4 | 70.1 | 91.2 |

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A catalyst for hydrocarbon conversion comprising:
(a) at least one element with a hydrogenation function,
(b) at least one type of microporous zeolite, and
(c) a porous, noncrystalline inorganic oxide having randomly interconnected mesopores and having an X-ray reflection in 2θ between 0.5 degrees to 2.5 degrees.

2. The catalyst of claim 1 wherein the at least one element with hydrogenation function is a metal selected from groups VIII, IB, IIB, VIIB and VIB of the Periodic Table of the Elements.

3. The catalyst of claim 1 wherein the at least one element having hydrogenation function is a metal selected from the group consisting of Pd, Pt, Ni, Mo, W, Rh, Ru, Cu and combinations thereof.

4. The catalyst of claim 1 wherein the composition percentage by weight of the element with hydrogenation function ranges from 0.2% to 30%.

5. The catalyst of claim 1 wherein the zeolite is selected from the group consisting of zeolite Beta, zeolite Y, ZSM-5, MCM-22, MCM-36, mordenite, Zeolite L, ZSM-11, ZSM-12, ZSM-20, Theta-1, ZSM-23, ZSM-34, ZSM-35, ZSM-48, SSZ-32, PSH-3, MCM-49, MCM-56, ITQ-1, ITQ-2, ITQ-4, ITQ-21, SAPO-5, SAPO-11, SAPO-37, Breck-6 and ALPO₄-5.

6. The catalyst of claim 1 wherein the composition percentage by weight of the zeolite ranges from about 3% to about 90%.

7. The catalyst of claim 1 wherein the inorganic oxide has at least one element selected from the group consisting of Si, Al, Ti, Co, Zn, La, Cu, Au, Mo, W, Cr, Ga, V, Ni, Fe, Mg, Zr and combinations thereof.

8. The catalyst of claim 1 wherein the inorganic oxide is selected from the group consisting of silica, alumina, titanium oxide, zirconium oxide and combinations thereof.

9. The catalyst of claim 1 wherein the inorganic oxide is alumina-silica.

10. The catalyst of claim 1 further comprising a fourth component selected from the group comprising boron, phosphorus or a combination thereof.

11. The catalyst of claim 1 further comprising a catalyst binder for shaping.

12. A process of making a catalyst comprising:
(a) making complexes as the precursor for the noncrystalline inorganic oxide with randomly interconnected mesopores;
(b) using the complexes from step (a) to make a composite having zeolite incorporated into the non-crystalline inorganic oxide with randomly interconnected mesopores;
(c) introducing at least one metal having a hydrogenation function into the composite made in step (b).

13. The process of claim 12 wherein the said complexes are selected from the group consisting of silitrane, alumatrane, titanatrane and their combinations.

14. The process of claim 12 wherein the zeolite is selected from the group consisting of zeolite Beta, zeolite Y, ZSM-5, MCM-22, MCM-36, mordenite, Zeolite L, ZSM-11, ZSM-12, ZSM-20, Theta-1, ZSM-23, ZSM-34, ZSM-35, ZSM-48, SSZ-32, PSH-3, MCM-49, MCM-56, ITQ-1, ITQ-2, ITQ-4, ITQ-21, SAPO-5, SAPO-11, SAPO-37, Breck-6 and ALPO₄-5.

15. The process of claim 12 wherein the metal is selected from groups VIII, IB, IIB and VIIB and VIB of the Periodic Table of the Elements.

16. A process for treating a hydrocarbon feed comprising:
contacting a feed containing at least one hydrocarbon component with a catalytically effective amount of a bifunctional catalyst comprising:
a) at least one element with a hydrogenation function,
b) at least one type of microporous zeolite, and
c) a porous, noncrystalline inorganic oxide having randomly interconnected mesopores and having an X-ray reflection in 2θ between 0.5 degrees to 2.5 degrees.

17. The process of claim 16 wherein the conversion of the hydrocarbon component is effected by means of a reaction selected from the group consisting of hydrocracking, hydrotreating, and hydroisomerization.

18. The process of claim 17 wherein said feed includes a petroleum fraction and the reaction conditions are sufficient to effect hydrocracking of the fraction to produce a relatively lighter hydrocarbon product.

19. The process of claim 18 wherein said petroleum fraction contains at least one component having a boiling point above about 260° C.

20. The process of claim 18 wherein said petroleum fraction contains at least one component having a boiling point above about 290° C.

21. The process of claim 18 wherein said petroleum fraction contains at least one component having a boiling point above about 340° C.

22. The process of claim 21 wherein said petroleum fraction further comprises at least one component selected from the group consisting of undeasphalted petroleum residua, deasphalted petroleum residua, tar sands bitumen, shale oil and coal liquid.

23. The process of claim 18 wherein said relatively lighter hydrocarbon product includes a component selected from the group consisting of middle distillate component having a boiling point ranging from 150° C. to 400° C., diesel fuel and lube base oil.

24. The process of claim 17 wherein the conversion of the hydrocarbon component is effected by means of hydroisomerization and the reaction conditions include a temperature of from about 150° C. to about 500° C., a pressure from about 1 bar to about 240 bars, and a LHSV from about 0.1 to about 20.
